(19) United States
(12) Patent Application Publication
(10) Pub. No.: US 2009/0289465 A1
(43) Pub. Date: Nov. 26, 2009

(54) Automobile Bumper Back Beam Structure

(75) Inventor: Su Young HEO, Gyeonggi-do (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/275,143

(22) Filed: Nov. 20, 2008

(30) Foreign Application Priority Data
May 16, 2008 (KR) 10-2008-0045814

(51) Int. Cl. B60R 19/18; B60R 19/04

(52) U.S. Cl. 293/120

(57) ABSTRACT

An automobile bumper back beam structure provided in a bumper cover comprises a guide member for preventing under-riding from being generated when vehicles collide. The guide member comprises a guide part which is concavely curved with an arc-shape and fixed at the bumper back beam in the bottom end of the guide part and a supporting part which is extended from the top end of the guide part and fixed at the bumper back beam in the bottom end of the guide part. The guide member for adjusting a height difference of bumpers prevents under-riding of the bumpers when automobiles collide at a low speed, and minimizes a damaged area, thereby reducing repair cost and alleviating shock to obtain stability and silence.

### CROSS-REFERENCE TO RELATED APPLICATION

Priority is claimed to Korean Patent Application Number 10-2008-0045814, filed on May 16, 2008, which is incorporated by reference in its entirety.

### BACKGROUND OF THE INVENTION

The present invention relates to an automobile bumper back beam structure, and more particularly, to an automobile bumper back beam structure comprising a guide member for preventing under-riding in a back beam to induce a stable collision when automobiles whose heights are different from each other collide.

In general, automobile bumpers are installed at the front and rear of an automobile to absorb a shock generated when the automobile collides with another automobile or an external object, thereby reducing the shock applied to the automobile and protecting not only the automobile body but also passengers.

Generally, the automobile bumper comprises a bumper cover and a bumper back beam.

The bumper cover is mounted to the front and the rear of the automobile to form an external housing, which absorbs a shock generated when the automobile first collides with an external object. The bumper cover is made from a polypropylene plastic material.

In addition, a buffering member is provided in the bumper cover to absorb the shock generated when the automobile collides with an external object.

The bumper back beam is formed to have a hollow cylinder shape and extended in the widthwise direction of the automobile. The bumper back beam is placed in the bumper cover to absorb a shock transmitted from the bumper cover.

Coupling pieces are formed at upper and lower portions of both end portions of the bumper back beam. The bumper back beam is fixed at the automobile body through the coupling pieces.

When a shock energy applied to the automobile in collision of the automobiles is transmitted to the bumper cover, the buffering member and the bumper back beam, the automobile bumper having the above-described structure reduces the impact remarkably, thereby obtaining stability.

However, when automobiles whose heights are different from each other collide at a low speed, under-riding occurs due to the difference of the heights of the automobiles. As a result, a damaged part of the automobile can become enlarged to cause excessive repair cost.

FIG. 1 is a sectional view showing a conventional automobile bumper back beam structure.

In order to solve the above problem, a reinforce member for preventing under-riding is provided in the bumper back beam.

As shown in FIG. 1, the conventional bumper back beam structure comprises a bumper cover 10 equipped with a buffering member 11 therein, a bumper back beam 20 supported to the buffering member 11, and a reinforce member 30 is provided on an upper surface of the bumper back beam 20 for preventing under-riding when the automobiles collide. The reinforce member 30 is formed over the bumper back beam 20.

However, the conventional reinforce member 30 causes the under-riding in collision of automobiles whose heights are different from each other due to lack of overlap. Also, the reinforce member is manufactured in a large size to increase the manufacturing cost.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Various embodiments of the present invention are directed at providing an automobile bumper back beam structure comprising a guide member for preventing under-riding in the bumper back beam so as to adjust a height difference of automobiles in collision of the automobiles, thereby remarkably reducing a shock from the collision, a damaged area and repair cost of the damage.

According to an exemplary embodiment of the present invention, an automobile bumper back beam structure provided in a bumper cover may comprise a guide member provided on a bumper back beam and positioned between the bumper cover and the bumper back beam, the guide member supporting the bumper cover elastically and preventing under-riding from being generated when vehicles collide.

In an exemplary embodiment of the present invention, the guide member may comprise a guide part concavely curved with an arc-shape surface and fixed on the bumper back beam at the bottom end of the guide part; and a supporting part extended from the top end of the guide part toward the inside of the bumper back beam and fixed on the bumper back beam at the bottom end of the supporting part. The guide part may be protruded toward the outside of the bumper back beam. The guide part may be protruded up to an inner-upper surface of the bumper cover. A buffering space may be formed between the guide part and the supporting part. At least a rib for enhancing the buffering function may be formed in the buffering space. The buffering space may comprise at least a honeycomb-shaped partition member. The guide member and the bumper back beam may be formed of integrally single body.

In another exemplary embodiment of the present invention, in the automobile bumper back beam structure, the guide member may comprise: a guide part concavely curved with a first predetermined curvature, wherein a bottom end portion of the guide part is fixed at the bumper back beam; and at least a supporting part extended concavely with at least a second predetermined curvature from the top end of the guide part toward the inside of the bumper back beam, wherein a bottom end portion of the at least a supporting part is fixed on the bumper back beam. The bottom end portion of the guide part may be fixed at a front surface of the bumper back beam; and the bottom end portion of the at least a supporting part may be fixed at upper surface of the bumper back beam. The guide part may be protruded toward the outside of the bumper back beam. The guide part may be protruded up to an inner-upper surface of the bumper cover. A buffering space may be formed between the guide part and the at least a supporting part. At least a rib for enhancing the buffering function may be formed in the buffering space. The buffering space may comprise at least a honeycomb-shaped partition member. The guide member and the at least a supporting part may be formed of integrally single body.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a sectional view showing a conventional automobile bumper back beam structure.

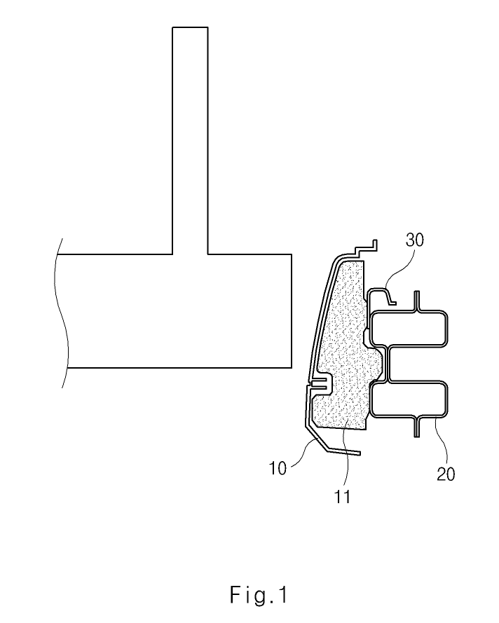

FIG. 2 is a sectional view showing an automobile bumper back beam structure according to an exemplary embodiment of the present invention.

FIG. 3 is a sectional view showing the operation of the automobile bumper back beam structure according to an exemplary embodiment of the present invention.

FIG. 4 is a sectional view illustrating an automobile bumper back beam structure according to another exemplary embodiment of the present invention.

In the figures, reference numbers refer to the same or equivalent parts of the present invention throughout the several figures of the drawing.

### DESCRIPTION OF SPECIFIC EMBODIMENTS

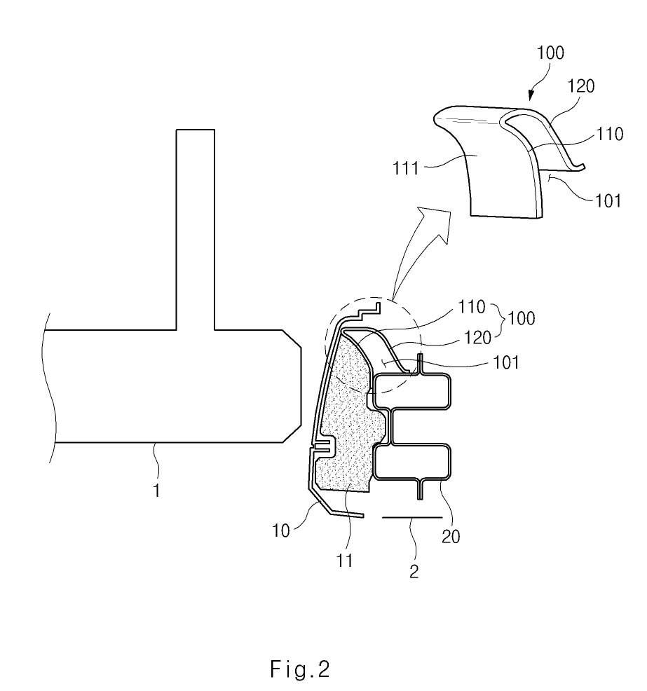

Hereinafter, an automobile bumper back beam structure according to an embodiment of the present invention will be explained in more detail with reference to FIGS. 2 to 4.

As shown in FIG. 2, an automobile bumper structure according to an exemplary embodiment of the present invention, which is provided to reduce a shock force and to protect passengers in a collision accident, comprises a bumper cover 10 provided at a front surface and a rear surface of an automobile to form an external housing, a bumper back beam 20 provided in the bumper cover 10 to alleviate the shock force, and a buffering member 11 provided between the bumper cover 10 and the bumper back beam 20 to absorb the shock force.

In other words, the shock force generated in a collision and passing through the bumper cover 10 is absorbed primarily by the buffering member 11. Then, the shock force is secondarily buffered by the bumper back beam 20, whereby the shock force is remarkably reduced.

However, when automobiles whose heights or sizes are different from each other collide at a low speed, the height difference of the bumpers causes under-riding.

To prevent such under-riding effect, the bumper back beam 20 comprises a guide member 100 for preventing under-riding of the higher positioned bumper occurring due to the height difference of the bumper.

Referring to an enlarged view shown in the right side of FIG. 2, the guide member 100 comprises a guide part 110 which is concavely curved with an arc-shape surface 111 and fixed on the outer surface of the bumper back beam 20 at the bottom end of the guide part 110 and a supporting part 120 which is extended convexly from the top end of the guide part 110 in the rear direction in the drawing and fixed at the top surface of the bumper back beam 20 at the bottom end of the guide part 110.

That is, in a collision of automobiles, the guide part 110 of the guide member 100 adjusts the height of the bumpers while the bumpers having a height difference is guided along the curved surface 111 of the guide part 110 when the higher-positioned bumper collides the bumper cover 10, and the supporting part 120 supports the rear surface of the guide part 110 elastically.

Specifically, the guide member 100 bends a rectangular elastic metal sheet into the shape “ [symbol] ” through a bending device (not shown), thereby forming the concave guide part 110 and the convex supporting part 120. The bottom ends of the guide part 110 and the supporting part 120 are fixed at the top surface of the bumper back beam 20 by fixing elements such as bolts and rivets.

The guide part 110 is protruded toward the outside of the bumper back beam 20, so that the bumper 1 is guided through a tilted angle of the curved surface 111 of the guide part 110 in a collision of automobiles to adjust the height difference of the bumpers rapidly.

In addition, the guide member 100 is extended up to the inner-upper surface of the bumper cover 10, thereby preventing under-riding generated in a collision of automobiles whose height difference is large.

Also, a buffering space 101 is formed between the guide part 110 and the supporting part 120 in the manufacturing of the guide member 100. The buffering space 101 can remarkably enhance the absorbing ratio of the impact force generated when automobiles collide.

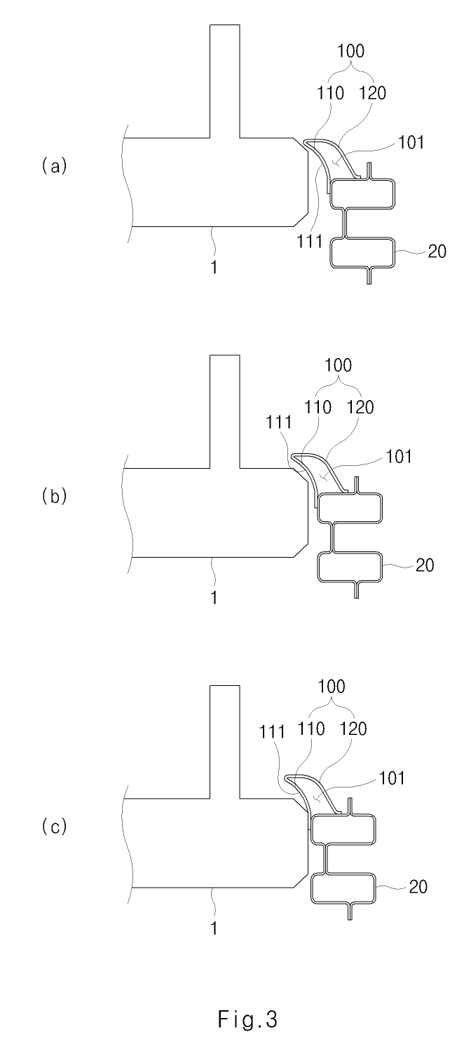

FIG. 3 is a sectional view showing the operation of the automobile bumper back beam structure according to an exemplary embodiment of the present invention.

When a smaller automobile in which the bumper back beam 20 is mounted with the guide member 100 collides with a larger automobile at a low speed, a bumper 1 of the larger automobile and a bumper 2 of the smaller automobile are compressed by a shock force.

While the bumper 1 of the larger automobile and the bumper 2 of the smaller automobile are compressed, under-riding simultaneously occurs by a height difference of the bumpers. However, the under riding can be prevented by the guide member 100.

That is, when the bumper 1 of the larger automobile collides with the bumper 2 of the smaller automobile, the guide member 100 mounted to the bumper 2 of the smaller automobile is engaged and supported with the top end of the bumper 1 of the larger automobile(see FIG. 3 (a)).

While the curved surface 111 of the guide member 100 is guided along the main surface of the bumper 1 of the larger automobile, the bumper 2 of the smaller automobile is lifted up, thereby adjusting the height difference with the bumper 1 of the larger automobile (see FIG. 3 (b)).

As the heights of the bumpers 1 and 2 of the automobiles are adjusted by the guide member 100, it is possible to prevent a damaged area from being enlarged and to alleviate the shock force remarkably (see FIG. 3 (c)).

Hereinafter, another embodiment of the present invention is illustrated. In the below description, the same numerical references are designated to the structural elements with the same functions as those of the above-described embodiment, and the detailed description thereon is omitted.

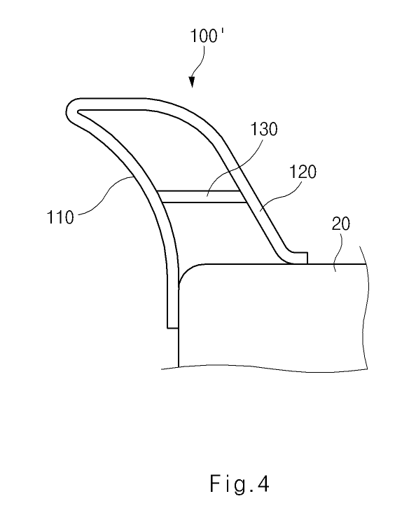

FIG. 4 is a sectional view illustrating the guide member 100 according to another embodiment of the present invention.

The guide member 100′ FIG. 4 may further comprise a rib 130 or a honeycomb-shaped partition member (not shown) to reinforce a buffering force or a strength in the buffering space 101. The above structure can remarkably enhance the buffering force of the guide member 100′, thereby preventing damage of the bumper and improving stability.

Meanwhile, the guide member 100 and the bumper back beam 20 may be formed integrally with each other according to convenience in manufacturing, reduction of manufacturing cost and a target automobile.

In this embodiment, after a portion of the surface of the bumper back beam (not shown) is removed to a given depth, a metal sheet is bent to form the guide member 100 with the shape as described above, and an end portion of the guide member 100 is then attached to the surface of the bumper back beam by welding or fusing methods to form the bumper back beam and the guide member integrally with each other.

As described above, an automobile bumper back beam structure according to an embodiment of the present invention comprises a guide member for adjusting a height difference of a bumper in the bumper back beam so as to prevent under-riding of the bumper in collision of automobiles. As a result, a damaged area can be minimized to reduce the repair cost and decrease the shock, thereby obtaining stability and comfort.

Although a number of illustrative embodiments of the present invention have been described, it should be understood that numerous other modifications and embodiments can be devised by those skilled in the art that fall within the spirit and scope of the principles of this disclosure. Particularly, numerous variations and modifications are possible in the component parts and/or arrangements which are within the scope of the disclosure, drawings, and the accompanying claims. In addition to variations and modifications in the component parts and/or arrangements, alternative uses will also be apparent to those skilled in the art.

What is claimed is:

1. An automobile bumper back beam structure provided in a bumper cover, comprising a guide member provided on a bumper back beam and positioned between the bumper cover and the bumper back beam, the guide member supporting the bumper cover elastically and preventing under-riding from being generated when vehicles collide.

2. The automobile bumper back beam structure according to claim 1, wherein the guide member comprises:
a guide part concavely curved with an arc-shape surface and fixed on the bumper back beam at the bottom end of the guide part; and
a supporting part extended from the top end of the guide part toward the inside of the bumper back beam and fixed on the bumper back beam at the bottom end of the supporting part.

3. The automobile bumper back beam structure according to claim 2, wherein the guide part is protruded toward the outside of the bumper back beam.

4. The automobile bumper back beam structure according to claim 2, wherein the guide part is protruded up to an inner-upper surface of the bumper cover.

5. The automobile bumper back beam structure according to claim 2, wherein a buffering space is formed between the guide part and the supporting part.

6. The automobile bumper back beam structure according to claim 5, wherein at least a rib for enhancing the buffering function are formed in the buffering space.

7. The automobile bumper back beam structure according to claim 5, wherein the buffering space comprises at least a honeycomb-shaped partition member.

8. The automobile bumper back beam structure according to claim 2, wherein the guide member and the bumper back beam are formed of integrally single body.

9. The automobile bumper back beam structure according to claim 1, wherein the guide member comprises:
a guide part concavely curved with a first predetermined curvature, wherein a bottom end portion of the guide part is fixed at the bumper back beam; and
at least a supporting part extended concavely with at least a second predetermined curvature from the top end of the guide part toward the inside of the bumper back beam, wherein a bottom end portion of the at least a supporting part is fixed on the bumper back beam.

10. The automobile bumper back beam structure according to claim 9, wherein the bottom end portion of the guide part is fixed at a front surface of the bumper back beam; and
the bottom end portion of the at least a supporting part is fixed at upper surface of the bumper back beam.

11. The automobile bumper back beam structure according to claim 9, wherein the guide part is protruded toward the outside of the bumper back beam.

12. The automobile bumper back beam structure according to claim 9, wherein the guide part is protruded up to an inner-upper surface of the bumper cover.

13. The automobile bumper back beam structure according to claim 9 wherein a buffering space is formed between the guide part and the at least a supporting part.

14. The automobile bumper back beam structure according to claim 13, wherein at least a rib for enhancing the buffering function are formed in the buffering space.

15. The automobile bumper back beam structure according to claim 13, wherein the buffering space comprises at least a honeycomb-shaped partition member.

16. The automobile bumper back beam structure according to claim 9, wherein the guide member and the at least a supporting part are formed of integrally single body.
